(19) United States
(12) Patent Application Publication
(10) Pub. No.: US 2003/0142131 A1
(43) Pub. Date: Jul. 31, 2003

(54) System for and method for the transference of information regarding status of an application program

(76) Inventor: Julie T. Dawe, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/066,132

(22) Filed: Jan. 30, 2002

(51) Int. Cl. G09G 5/00

(52) U.S. Cl. 345/764

(57) ABSTRACT

The present invention includes a method of generating a visually perceptible output indicating a status of an application program. The method preferably includes receiving a first data stream having a first format and encapsulating the first data stream into a predetermined second format. A first set of rules are then preferably applied to organize the information contained in the second format and aggregate the information into a plurality of categories. Each of these categories is preferably related to parameters, and the parameters are displayed via a graphical representation of the changes in the information contained in the first data stream.

### TECHNICAL FIELD

The current invention relates generally to the transference of information from a computer system to a user, and more particularly to visually and/or aurally transferring information regarding the status of an application program.

### BACKGROUND

In many computer related systems, processes or applications run primarily without user intervention until completion of the process or application. However, lack of data, errors, miscommunication between coordinating software applications, errors in timing, or other circumstance may occur which halt or stop computer processes or applications before completion. In such a situation human intervention may be required, possibly on a time critical basis to permit the process or application to continue.

There are many computer processes that monitor computer operations. One of these computer processes monitors the computer operation and displays a representation of the computer operation in the form of a log file or a binary status indicator, for example a green or red light. A representation of another more sophisticated monitor is a central processing unit (CPU) monitor which graphically displays the load on an associated processor. These displays allow an operator to monitor or oversee the display and to intervene when required.

A ‘collector’ from the product called ‘Internet Usage Manager’ from Hewlett Packard also displays a limited amount of information with respect to its operation. A collector, as the name implies, collects data from various sources and may “aggregate” and store the data. A computer user may be informed that a collector is working properly by an indication on the computer screen, such as a green “light” next to the name of the collector element. Additionally, a user may view a log file which is created as the collector operates to confirm proper operation or to identify problems. Log files provide a plethora of information and may be technically difficult to interpret. In many cases, the log file contains more information than an operator needs simply to confirm proper operation. Alternatively, the previously described green light only indicates proper operation and often does not provide enough information to the user or operator.

A collector may include an encapsulator, an aggregator, and a data store. The encapsulator reads data from an outside source. Examples of the source of the data could be anything from a router, a switch in a network, or a log file from a proxy server. The next stage of the collector, the aggregator applies predefined rules to the collected data. Once the rules are applied, the resulting data is written into the data store portion of the collector.

The aggregator may be used to modify data, combine data fields, set data fields to zero, or otherwise modify specific data fields. The datastore can change the output of the data to a specific format or configuration. A datastore may, for instance, be used to format the data for storage in a database, or in an HTML or XML file. Process information may be displayed to the user in the form of a log file or a green status light.

Various other computer-to-human interfaces or man-machine interfaces have been developed and are currently available. These interfaces may be configured to provide a visual output synchronized with an audio output. For example, various amusement and entertainment packages allow a computer to play audio files and generate a visual display on a computer screen which is synchronized with the audio output. In this configuration, the computer uses the rhythm or the beat of the music and transforms that information into a visual display.

Similarly, information may be presented to a user by using a computer to receive, massage and display information in an organized manner. For example, a stock market tracking program from smartmoney.com creates a broad visual image using colored blocks to illustrate current stock market activity. This display is used by investors to get a feel for which stocks are trading and which stocks are not trading. These interface and display programs have not been applied to encapsulators or collectors.

### SUMMARY OF THE INVENTION

In one embodiment, the present invention includes a method of generating a visually perceptible output indicating a status of an application program. The method preferably includes receiving a first data stream having a first format and encapsulating the first data stream into a predetermined second format. A first set of rules are then preferably applied to organize the information contained in the second format and aggregate the information into a plurality of categories. Each of these categories is preferably related to parameters, and the parameters are displayed via a graphical representation of the changes in the information contained in the first data stream.

According to another embodiment, the present invention provides a system for generating a visually perceptible output indicative of a status of an application program. Preferably, an encapsulator of the system is configured to encapsulate a first data stream output in a first format from the application program into a predetermined second format. An aggregator of the system is preferably configured to aggregate information contained in the first data stream output in the second format by applying a first set of rules organizing the information into a plurality of categories. A display is preferably configured to display a graphical representation of parameters relating to each of the categories in response to changes in the information contained in the first data stream.

### BRIEF DESCRIPTION OF THE DRAWINGS

FIG. 1 is a first embodiment of a system according to the present invention.

FIG. 2 is a second embodiment of a system according to the present invention.

FIG. 3 is an example of an input log file which may be processed according to the present invention.

FIG. 4 is an embodiment of the present invention for the artistic transfer of information.

FIG. 5 is another embodiment of the present invention for the artistic transfer of information.

FIG. 6 is another embodiment of the present invention for the artistic transfer of information.

### DETAILED DESCRIPTION

The present invention is directed to systems and methods which provide a simplified presentation to a user of information pertaining to a computer process or application. This information may be presented in an artistic (visually pleasing and informative), meaningful manner using, for example, a computer display representing various program parameters and/or conditions.

The present invention may provide an enhanced visual representation summarizing information concerning the status and/or operation of a computer program. The representation is intended to visually display meaningful information to a computer operator. The status or operation may be associated with and/or represented by combinations of colors, symbols, orientation, prioritization, or other formatting effects of a displayed icon or other information representation such as an analog gauge. For instance, an icon representing a process which has failed may include a red outline to denote the failure of the process. Alternatively, a red “x” may be placed through the icon, a failure message within a log file may be highlighted in red, a red halo or glow may be displayed around the icon, or similar visual effects may be used to provide information concerning the process to the user.

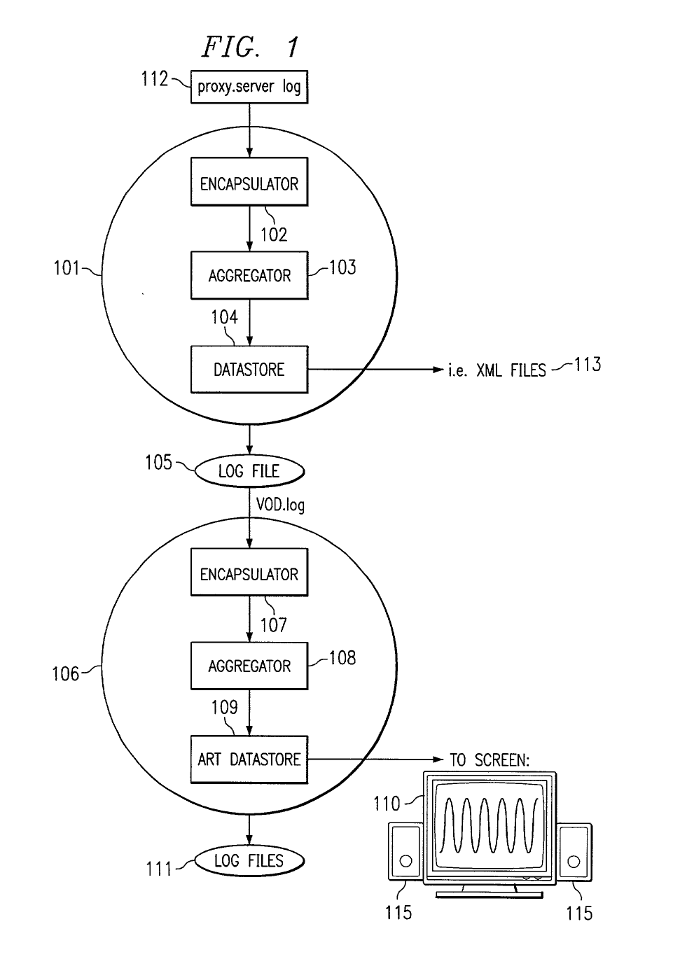

FIG. 1 is a first embodiment of the present invention incorporated into a system for monitoring an application process. The system depicted in FIG. 1 includes two collectors, source collector 101 and “art” collector 106. As shown, collector 101 is preferably configured to read data from proxy server log 112. Encapsulator 102 of collector 101 is preferably configured to receive the data. Aggregator 103 is preferably configured to aggregate the data from encapsulator 102 by applying various rules. Data store 104 is preferably configured to store the results in file 113, such as may be an XML file or other data file format.

Collector 101 is preferably configured to generate its own log file as information concerning processed events. According to the illustrated embodiment, the log file generated by collector 101 is written to log file 105. One of ordinary skill in the art would appreciate other storage mechanisms are equally applicable to the present invention.

“Art” collector 106 of FIG. 1 is configured to include various aspects of the present invention. Art encapsulator 107 of art collector 106 preferably receives information from log file 105. Encapsulator 107 may be used to extract information from data source where the data is stored in a specific information, such as a predetermined first format, and to store the data in an alternative, different, common or predetermined second format. For example, encapsulator 107 receives a log file, such as a VOD.log in which the contained data is stored in a first format. This first format may be inconsistent with information contained from other sources. Encapsulator 107 may reformat the data from the predetermined first formal found in VOD.log to a predetermined second format for use by Aggregator 108. Various aggregators may be used to reformat data received from various sources. Information received by art encapsulator 107 is preferably provided to aggregator 108 which applies any necessary rules. Rules may be used to strip or remove unnecessary data from the information received from encapsultor 107, to normalize the format of the information, to combine information from various files or to perform similar manipulations on the data. Rules may also be used to organize information into a plurality of categories. If the application of rules are not necessary, aggregator 108 may be eliminated, if desired. In either case, data store 109 may be the source of information to be presented on screen 110 and/or output through speakers 115. Data store 109 may store data in a database, text file or any other storage means in which information may be stored and recovered. Art collector 106 may also generate its own log file 111.

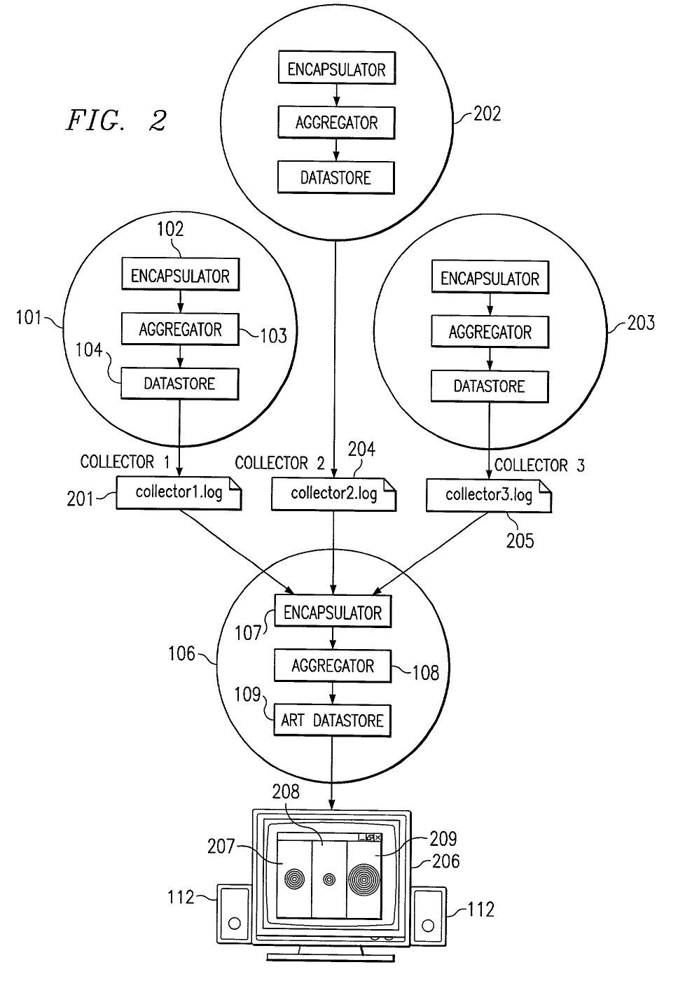

FIG. 2 illustrates a second embodiment of the present invention. Collector1.log 201, collector2.log 204, and collector3.log 205 serve as inputs to encapsulator 107 of this embodiment. Encapsulator 107 preferably receives and combines information from those three sources and provides the information to aggregator 108. Aggregator 108 applies rules, similar to those described previously, to the information received and processed by encapsulator 107. For example, aggregator 108 may search for all informative or warning messages. Alternatively, rules implemented in aggregator 108 may highlight debug level errors.

Art store 109 may be configured to display some attention-getting graphic, such as a blue line on a computer whenever the word “informative” is present in the log file. After the blue line is displayed (as shown in FIG. 1), the cursor on the screen is shifted to the right. This movement to the right may signify a passage of time. Similarly concentric circles may be used to simulate the passage of time where the outer circles represent events which occur at a later time than events associated with interior circles. Portion 207 of display 206 may “graph” activity received from collector1.log 201. For example, when processing is occurring normally, a green line may be drawn, every time the word “informative” is received, a blue line may be drawn and every time the word “warning” is received, a yellow line may be drawn, a fatal problem may be represented with a red line. Changes in processing status may be shown with changes in colors. The normal processing, informative messages, warnings and data errors may each be considered parameters relating to the processing status being displayed. Portions 207, 208 and 209 of screen 206 display graphical representations of these parameters and as the graphical representation changes, a change in the represented parameters is identified. Display 206 may be a monitor for a personal computer. One of ordinary skill in the art would appreciate the graphical representation of the parameters on the screen may be analog representations of the underlying information.

Screen portion 207 of display 206 preferably continues to display the status of the process reflected by a particular collector, such as collector1.log 201. As the log file grows, the screen preferably changes to include lines associated with new information as described above and the color of the changes indicate the content of the log file. Continuing blue lines indicate, for example, informative statements while a persistent yellow color may indicate the presence of a large number of warning statements. Similarly, status of a second process, such as stored in collector2.log, may be displayed on screen portion 208 of display 206 and status of a third process, such as stored in collector3.log, may be displayed on screen portion 209. With this configuration, a glance at screen 206 would convey the status of all three processes to the user. If the screen contains yellow, one or more warnings may be present. If, for instance, orange was present, an error occurred and trouble shooting, or debug, may be necessary.

One of ordinary skill in the art would understand that colors can be used to portray any information contained within the log files. Additionally, one of ordinary skill in the art would understand that the present invention is not limited to inputs from log files, description information coded by specific configurations such as colors, or three statuses displayed on a single screen. For instance, the present invention includes a configuration in which information from collector 101 is sent directly to encapsulator 107 (without a collector1.log file), and display 207 displaying circles for normal operations, squares for minor problems, and crosses for fatal problems. The current invention further includes the incorporation of the information into the displays to enable an operator to gain an understanding of the overall status of the process or processes from the display.

In addition to visual displays, sounds can be incorporated into the present invention. For instance, a warning sound, such as a siren, may be sounded if a fatal error is encountered.

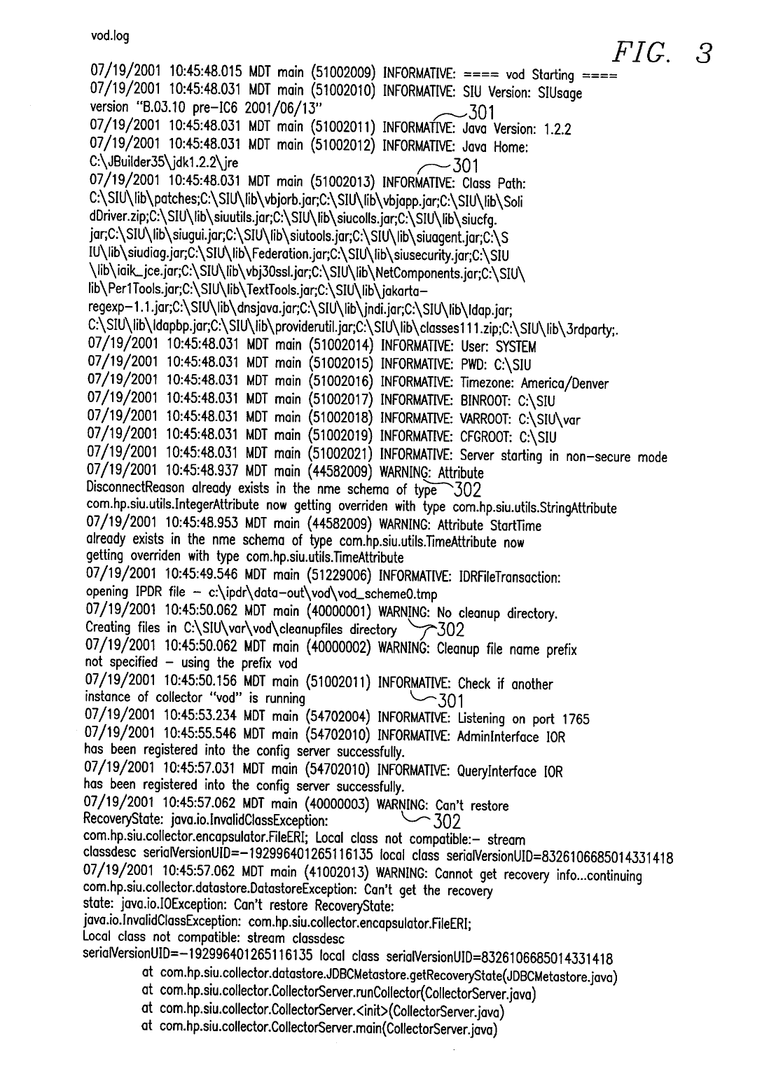

FIG. 3 shows an example log file which may be used as an input for the present invention. Informative statement 301 in FIG. 3 may be displayed on a computer screen or other display device as a blue line according to the above-described embodiment to indicate the presence of the Informative Statement 301. Additionally, warning statement 302 may be displayed on a display device as a yellow line according to the above-described embodiment. One of ordinary skill in the art would understand the presence of these statements may be brought to the attention of the operator through other methods as well. For instance, the presence of warning statements 302 may be indicated by an audible alert, a yellow coloring, a symbol, the display of a predefined message or any other manner intended to alert the operator to the presence of the warning statement. Alternatively, a fatal error may be indicated by a bell or alarm. One of ordinary skill in the art would appreciate that the log file of FIG. 3 may be stored on a computer readable media such as a diskette, a hard drive, a compact disc or similar medias.

FIGS. 4-6 show alternative embodiments of display schemes according to the present invention for the artistic transfer of information. One of ordinary skill in the art would appreciate that various displays and display formats may be created to present information. FIG. 4 shows the artistic display of data for an encapsulator, an aggregator and a datastore. Display 401 conveys information to a user concerning the status of the encapsulator. Similarly, displays 402 and 403 convey information concerning the aggregator and datastore respectively. In this example, cross hatching, as shown in display 401 may indicate the absence of any problems in the operation. Display 402 includes “x's” indicating a problem is present. A user may obtain additional information by placing the cursor over the area. In response, software included in the system would display a pop-up window to the user containing detailed information. Display 403 includes a number of question marks signifying that no data has been processed to this point. In a preferred embodiment displays 401, 402 and 403 use color to convey information to the user. For example, display 401 may be green in color indicating the operation is proceeding satisfactorily. Display 402 may be red in color indicating a problem has been encountered. Display 403 may be blue indicating no data has yet been received. One of ordinary skill would appreciate other indicators may be used including colors, movement, highlighting, sounds, or similar features to attract the attention of the user.

FIG. 5 shows the encapsulator display 501, aggregator display 502 and datastore display 503 according to another embodiment of the present invention. Markings, colors, shapes and/or similar indicators may be used to present status information to the user.

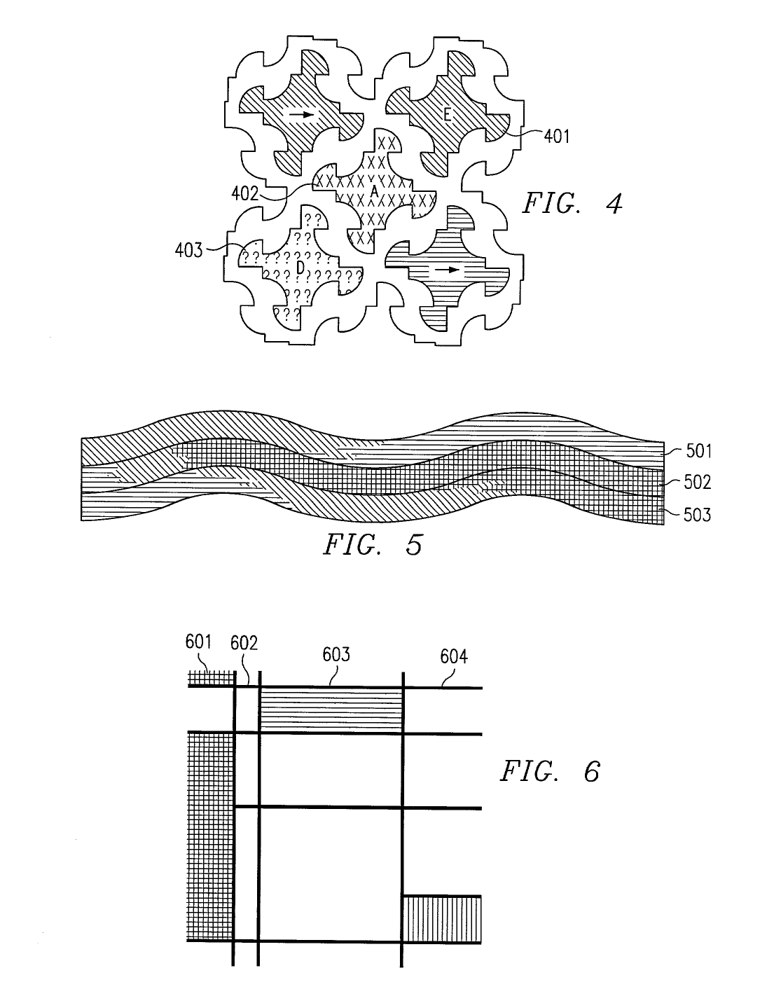

FIG. 6 shows an alternate embodiment of the present invention. Columns 601 and 602 show the status of the encapsulator, while columns 603 and 604 present aggregator and datastore information respectively. Markings, colors, or similar highlights may be used to convey information to the user. Additionally, information may be presented to the user through mouse location or user selections.

What is claimed is:

1. A method of generating a visually perceptible output indicative of a status of an application program comprising steps of:
receiving a first data stream having a first format;
encapsulating said first data stream in said first format into a predetermined second format;
aggregating information contained in said first data stream output in said second format by applying a first set of rules organizing said information into a plurality of categories; and
displaying a graphical representation of parameters relating to each of said categories in response to changes in said information contained in said first data stream.

2. The method of claim 1 further including the step of:
encoding an aural representation of parameters relating to each of said categories in response to changes in said information contained in said data stream in said second format.

3. The method of claim 1 further including the step of:
defining a color palette, wherein colors of the color palette are associated with human recognized process status conditions and represent the status conditions.

4. The method of claim 1 wherein said steps of receiving, encapsulating, aggregating and displaying are performed in real time with respect to said application program.

5. The method of claim 1, further including the step of:
creating an artistic graphical representation for presentation of information to a user.

6. The method of claim 5, further including the step of:
defining a color palette, wherein colors of the color palette are associated with human recognized process status condition and represent the status condition.

7. A system for generating a visually perceptible output indicative of a status of an application program comprising:
an encapsulator 107 configured to encapsulate a first data stream output in a first format from said application program into a predetermined second format;
an aggregator 108 configured to aggregate information contained in said first data stream output in said second format by applying a first set of rules organizing said information into a plurality of categories; and
a display 110 configured to display a graphical representation of parameters relating to each of said categories in response to changes in said information contained in said first data stream output.

8. The system of claim 7 wherein said display is further configured to generate an analog representation of said information.

9. The system of claim 7 further including:
an encoder 109 for encoding an aural representation of parameters relating to each of said categories in response to changes in said information contained in said data stream output.

10. The system of claim 7 further including:
a color palette, wherein the color palette includes colors which are associated with human recognized process status conditions and are used to represent the status conditions.

11. The system of claim 7 further including:
an artistic graphical representation for presentation of information to a user.

12. The system of claim 11 further including:
a color palette, the colors of which are associated with human recognized process status condition and used to represent the status condition.

13. A computer readable media containing a software program for generating a visually perceptible output indicative of a status of an application program comprising software configured to:
encapsulate a first data stream in a first format from said application program into said predetermined second format;
aggregate information contained in said first data stream output in said second format by applying a first set of rules organizing said information into a plurality of categories; and
display a graphical representation of parameters relating to each of said categories in response to changes in said information contained in said first data stream output.

14. The computer readable media of claim 13 wherein the software is further configured to:
encode an aural representation of parameters relating to each of said categories in response to changes in said information contained in said data stream output.

15. The computer readable media of claim 13 wherein the software is further configured to:
define a color palette the colors of which are associated with human recognized process status conditions and representing the status conditions.

16. The computer readable media of claim 13 wherein the software is further configured to:
encapsulate a second data stream output in a third format from said application program into said predetermined second format;
aggregate information contained in said second data stream output in said third format by applying a second set of rules organizing said information into a plurality of categories; and
display a graphical representation of parameters relating to each of said categories in response to changes in said information contained in said second data stream output.

17. The computer readable media of claim 16 wherein the software is further configured to:
encode a aural representation of parameters relating to each of said categories in response to changes in said information contained in said data stream output.

18. The computer readable media of claim 16 wherein the software is further configured to:
define a color palette the colors of which are associated with human recognized process status conditions and representing the status conditions.
